(19) United States
(12) Patent Application Publication
(10) Pub. No.: US 2020/0309080 A1
(43) Pub. Date: Oct. 1, 2020

(54) SYSTEM AND METHOD FOR CONTROLLING VEHICLE STOP-START FUNCTION BASED ON MEASURED AND PREDICTED CRANKING VOLTAGES AND ADAPTIVE ADJUSTMENT OF CIRCUIT RESISTANCE

(71) Applicant: Ford Global Technologies, LLC, Dearborn, MI (US)

(72) Inventors: Hanyang B. Chen, Canton, MI (US); David W. Linden, Ann Arbor, MI (US); Ravi Atluru, Novi, MI (US); Michael Irby, Monroe, MI (US)

(21) Appl. No.: 16/372,321

(22) Filed: Apr. 1, 2019

(51) Int. Cl. F02N 11/08

(52) U.S. Cl. CPC F02N 11/0825; F02N 2200/062; F02N 2200/063; F02N 2200/022; F02N 2200/044; F02N 2200/043; F02N 2200/0801

(57) ABSTRACT

A vehicle determines a first resistance of a starter motor and a starter cable connected thereto based at least in part on the first voltage of a power source. The vehicle determines a predicted minimum battery voltage based at least in part on the first resistance of the starter motor and the starter cable. The vehicle, in response to the predicted minimum battery voltage satisfying a threshold, enables a vehicle stop-start function, and, in response to the predicted minimum battery voltage failing to satisfy the threshold, disables the vehicle stop-start function.

### TECHNICAL FIELD

The present disclosure generally relates to a system and method for controlling a vehicle stop-start (SS) function based on measured and predicted cranking voltages and adaptive adjustment of circuit resistance and, more specifically, a system and method for enabling/disabling a vehicle SS function based on measured and predicted cranking voltages and adaptive adjustment of circuit resistance .

### BACKGROUND

Vehicle SS function allows a vehicle engine to automatically turn-off when a brake pedal is actuated and to automatically start (i.e., crank) when the brake pedal is relieved. Vehicles typically draw power from a 12-volt battery to crank the engine. Such battery is electrically coupled to various vehicle loads. These loads may be negatively impacted (e.g., shut down) when an engine crank occurs since an engine crank draws substantial amount of power form the battery.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

An example vehicle and method are described herein. The example vehicle includes at least one load, a starter motor, a starter cable connected to the starter motor, sensors, a power source electrically coupled to the starter motor and said load, a processor, and memory storing instructions executable by the processor. The instructions, when executed by the processor, cause the processor to operate with the sensors to: during an engine crank, determine a first voltage of the power source; determine a first resistance of the starter motor and the starter cable based at least in part on the first voltage of the power source; determine a predicted minimum battery voltage based at least in part on the first resistance of the starter motor and the starter cable; responsive to the predicted minimum battery voltage satisfying a threshold, enable a vehicle stop-start function; and responsive to the predicted minimum battery voltage failing to satisfy the threshold, disable the vehicle stop-start function.

The example method includes: during a vehicle engine crank, determining via, vehicle a first voltage of a power source of a vehicle, wherein the power source is electrically coupled to a starter motor of the vehicle and at least one load of the vehicle; determining a first resistance of a starter motor of the vehicle and a starter cable of the vehicle based at least in part on the first voltage of the power source; determining a predicted minimum battery voltage based at least in part on the first resistance of the starter motor and the starter cable; responsive to the predicted minimum battery voltage satisfying a threshold, enabling a vehicle stop-start function; and responsive to the predicted minimum battery voltage failing to satisfy the threshold, disabling the vehicle stop-start function.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates a vehicle in accordance with this disclosure.

FIG. 2 illustrates an example graph of battery voltage change over time.

FIG. 3 illustrates an example flowchart of a method for controlling SS function based on measured and predicted cranking voltages and adaptive adjustment of starter resistance.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Vehicles include a Stop-Start (SS) function for improving fuel-economy. The SS function allows a vehicle engine to automatically turn-off when a brake pedal is actuated and to automatically start when the brake pedal is relieved. Typically, the vehicle engine is restarted by a 12-volt battery, which is used to support various electric loads in a vehicle. Since the 12-volt battery powers a plurality of electric loads, it is critical that a minimum battery voltage is maintained to fully power the plurality of electric loads even when the vehicle is engine is restarted for the SS function. To mitigate depletion of power in said plurality of electric loads, these vehicles may: (1) determine a minimum acceptable voltage for auto re-cranking; (2) calculate a predicted minimum voltage for auto re-cranking based at least in part on a state-of-charge (SoC) of a vehicle battery, battery voltage, battery temperature, battery internal resistance, vehicle electric loads, and electric resistance of vehicle starter and cable; and (3) disable the SS feature when the predicted minimum voltage is lower than the minimum acceptable voltage. The starter and cable electric resistance is strongly dependent on a starter and cable temperature. Typically, such temperature is estimated based on engine inlet temperature, engine coolant temperature, vehicle speed, and other vehicle parameters and status. In addition, starter/cable resistance changes based on aging status of starter motor and connection. Based on lab and field data, manufacturers may correlate the starter and cable electric resistance with these variables. However, since the actual values of starter and cable temperature and its corresponding electric resistance are variable with respect to a plurality factors, it may be challenging to render accurate estimation of the same.

As disclosed herein, a vehicle includes a vehicle cranking system and an on-board computing platform. The Vehicle cranking system includes at least one load, a starter motor, a starter cable connected to the starter motor, sensors, a power source electrically coupled to the starter motor and said load. The on-board computing platform includes a processor, and memory storing instructions executable by the processor. The instructions, when executed by the processor, cause the processor to operate with the sensors to: (1) determine a minimum voltage level of the power source during an engine crank; (2) determine a first resistance of the starter motor and the starter cable based on the minimum voltage level, an internal resistance of the power source, and a voltage-before-crank, wherein the voltage-before-crank is defined as a function of an electromagnetic force of the power source, a current consumed by said load, and a resistance of said load; (3) determine a predicted minimum battery voltage based on the voltage-before-crank, the first resistance of the starter motor and the starter cable, and the internal resistance of the power source; (4) in response to the predicted minimum battery voltage satisfying a threshold, enable a vehicle stop-start function; and (5) in response to the predicted minimum battery voltage failing to satisfy the threshold, disable the vehicle stop-start function.

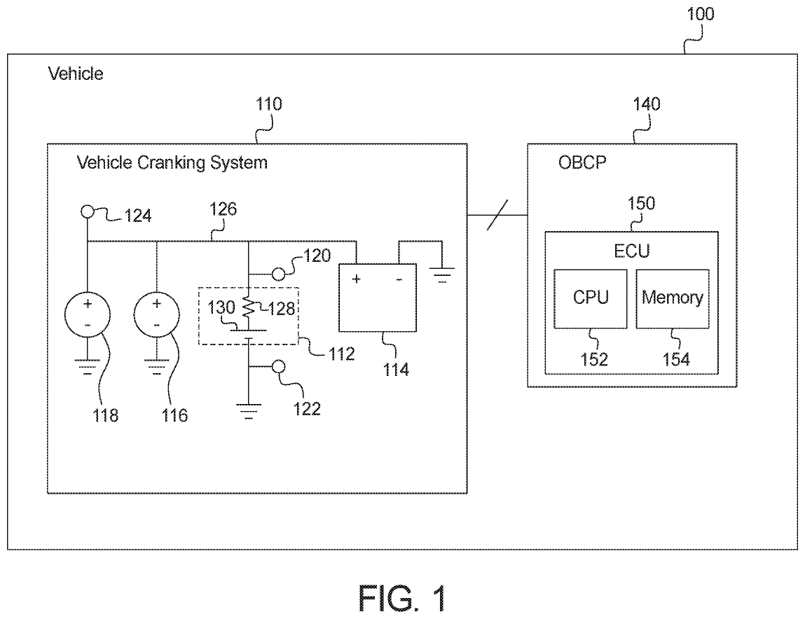

FIG. 1 illustrates the vehicle 100 in accordance with this disclosure. The vehicle 100 may be a standard gasoline powered vehicle, a hybrid vehicle, an electric vehicle, a fuel cell vehicle, and/or any other mobility implement type of vehicle. The vehicle 100 may be a semi-autonomous vehicle (e.g., some routine motive functions, such as parking, are controlled by the vehicle), or an autonomous vehicle (e.g., motive functions are controlled by the vehicle without direct driver input). The vehicle 100 includes a vehicle cranking system 110 and an on-board computing platform 140.

In the illustrated example, the vehicle cranking system 110 includes a power source 112, a load 114, a starter motor 116, a voltage generator 118, first sensor 120, second sensor 122, third sensor 124, and a power bus 126. The power source 112 may be a 12-volt lead-acid battery. The power source 112 may be defined by a resistor 128 and a capacitor 130. The resistor 128 resembles the internal resistance of the power source 112. The load 114 may be any one of various vehicle modules and accessories such as exterior lighting, interior lighting, Passive Entry Passive Start (PEPS) system, infotainment system, an electronic instrument cluster, a body control module (BCM), a HVAC modules configured to provide control and monitoring of heating and cooling system components (e.g., compressor clutch and blower fan control, temperature sensor information, etc.), etc. It should be appreciated that multiple loads may be electrically coupled to the vehicle cranking system 110. The starter motor 116 110 may be a DC electric motor or may be an AC motor. The voltage generator 118 may be a 12-volt generator. The voltage generator 118 may be a vehicle alternator. The power source 112, the load 114, the starter motor 116, and the voltage generator 118 may be electrically coupled to each other in parallel. These elements may be electrically coupled to each other via the power bus 126. In some examples, the power bus 126 may be a 12-volt DC bus. The first to third sensors 120, 122, and 124 may be voltage and/or current sensors. The first sensor 120 may be electrically coupled to a node shared by the power source 112, the starter motor 116, the voltage generator 118, and the load 114. The second sensor 122 may be electrically coupled to a node shared by the power source 112 and the ground. The third may be electrically coupled to one of the terminals (e.g., positive) of the voltage generator 118. It should be appreciated that one or more additional voltage/current sensors may be further electrically coupled to one or more terminals of the power source 112, the resistor, the load 114, the starter motor 116, and/or the voltage generator 118 and/or one or more nodes within the vehicle cranking system 110.

In the illustrated example, the on-board computing platform 140 includes an electronic control unit (ECU) 150, which may be defined by at least one processor or controller 152 and at least one memory 154. It should be appreciated that the on-board computing platform 140 may resemble any one or more of various vehicle modules having computing/processing capabilities, such as a body control module (BCM), a powertrain control module, etc. The processor or controller 152 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 154 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, non-volatile solid-state memory, etc.), unalterable memory (e.g., EPROMs), read-only memory, and/or high-capacity storage devices (e.g., hard drives, solid state drives, etc). In some examples, the memory 154 includes multiple kinds of memory, particularly volatile memory and non-volatile memory.

The memory 154 is computer readable media on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 154, the computer readable medium, and/or within the processor 152 during execution of the instructions.

The terms “non-transitory computer-readable medium” and “tangible computer-readable medium” should be understood to include a single medium or multiple media, such as a centralized or distributed database, and/or associated caches and servers that store one or more sets of instructions. The terms “non-transitory computer-readable medium” and “tangible computer-readable medium” also include any tangible medium that is capable of storing, encoding or carrying a set of instructions for execution by a processor or that cause a system to perform any one or more of the methods or operations disclosed herein. As used herein, the term “tangible computer readable medium” is expressly defined to include any type of computer readable storage device and/or storage disk and to exclude propagating signals.

In the illustrated example, the on-board computing platform 140 is electrically coupled to the vehicle cranking system 110. For example, the ECU 150 of the on-board computing platform 140 may electrically and/or communicatively coupled to at least one of a group consisting: the power source 112, the load 114, the starter motor 116, the voltage generator 118, first to third sensors 120, 122, and 124, and the power bus 126. The ECU 150 may receive sensor data from the first to third sensors 120, 122, and 124 to determine voltage/current/resistance of various components within the vehicle cranking system 110.

Operations of the ECU 150 will be described in detail below with reference to the overall system(s) and components(s) within the vehicle of FIG. 1.

The ECU 150 is operable to enable or disable a Stop-Start (SS) function. As discussed above, the SS function allows a vehicle engine to automatically turn-off when a brake pedal is actuated and to automatically start when the brake pedal is relieved. The ECU 150: (1) calculates a predicted minimum battery voltage V_Crank_Predicted; (2) compares the predicted minimum battery voltage V_Crank_Predicted to a minimum acceptable voltage (V_MinCrank_Threshold); and (3) enables or disables the SS function based on the comparison. The ECU 150 may perform these functions a number of times during a key cycle. Herein, a key cycle is a period defined by a time point in which the vehicle is electrically powered to a subsequent time point in which the vehicle is electrically unpowered. The number of times in which said functions are performed corresponds to a number of times in which an engine crank occurs. Details in which the ECU 150 sets the SS function over a key cycle will be described below

When the vehicle is electrically powered (e.g., when a vehicle key is inserted into a key slot), but the ignition or the engine thereof has not been activated yet, the ECU 150 calculates the predicted minimum battery voltage V_Crank_predicted, which is defined by equation 1, below:

V_Crank_predicted=V_BeforeCrank×R_StarterCable/(R_StarterCable+R_Battery_Internal) [Equation 1]

V_BeforeCrank defines a voltage before an engine crank. V_BeforeCrank is defined by equation 2, below:

V_BeforeCrank=EMF−I_load 114×R_load 114 [Equation 2]

EMF defines an electromotive force of the power source 112. The ECU 150 may determine EMF by measuring, via the first and second sensor 122s, the potential difference across the terminals of the power source 112 when no current is flowing through the power source 112. I_load 114 defines an amount of current consumed by the load 114. The ECU 150 may determine I load 114 based on sensor data received from the first sensor 120 and the third sensor 124. For example, I_load 114 may be a difference between an output current of the voltage generator 118 and an output current of the power source 112. R_load 114 defines an equivalent resistance of the load 114. The ECU 150 may determine R_load 114 based on sensor data received from the first sensor 120 and the third sensor 124. For example, the ECU 150 may determine the resistance of the load 114 based on a difference between a current/voltage sensed at the first sensor 120 a current/voltage sensed at the third sensor 124. Alternatively, the load 114 may provide data including information about R_load 114 to the ECU 150. R_StarterCable defines a total resistance of the starter motor 116 and one or more cables physically and electrically connected thereto. At the beginning of a key cycle, prior to a first instance of an engine crank in the key cycle, the ECU 150 may determine R_StarterCable as a predetermined value stored in, for example, the memory. The predetermined value may be determined at a time point in which the vehicle was manufactured. The predetermined value may be an estimated value of the total resistance of the starter motor 116 and said cable connected thereto. R_Battery_Internal defines a resistance of the power source 112. The ECU 150 may determine R_Battery_Internal based on sensor data received from the first sensor 120 and the second sensor 122.

When the ignition or the engine of the vehicle is activated for the first instance in the key cycle (e.g., when the vehicle key is turned while in the key slot or when the push button is actuated), the ECU 150 measures BattCrankVoltage based on sensor data received from the first sensor 120 and the second sensor 122. BattCrankVoltage defines a minimum cranking voltage level measured at the power source 112 when the ignition or the engine of the vehicle is activated. Herein, the first instance within the key cycle and in which the ignition or the engine of the vehicle is activated is referred as a cold crank, and any subsequent instance within the key cycle and in which the ignition or the engine of the vehicle is activated is referred as a warm crank.

When the engine of the vehicle is running, the ECU 150 adjusts R_StarterCable based on equation 3:

R_starterCable=BattCrankVoltage×R_Battery_Internal/(V_BeforeCrank−BattCrankVoltage). [Equation 3]

Based on the adjusted R_StarterCable, the ECU 150 recalculates V_Crank_Predicted. Subsequently, the ECU 150 compares the predicted minimum battery voltage V_Crank_Predicted to the minimum acceptable voltage threshold V_MinCrank_Threshold. The minimum acceptable voltage threshold V_MinCrank_Threshold may correspond to a minimum voltage level required by the power source 112 to electrically supply the load 114 when the voltage generator 118 ceases to generate power (e.g., when a vehicle brake is applied). If the predicted minimum battery voltage V_Crank_Predicted is greater than the minimum acceptable voltage threshold V_MinCrank_Threshold, the ECU 150 allows the SS function to, if previously enabled, remain enabled. In some examples, if the predicted minimum battery voltage V_Crank_Predicted is greater than the minimum acceptable voltage threshold V_MinCrank_Threshold, the ECU 150 may set the SS function to be enabled regardless of the previous state of the SS function. If the predicted minimum battery voltage V_Crank_Predicted is less than the minimum acceptable voltage threshold V_MinCrank_Threshold, the ECU 150 disables, if previously enabled, the SS function.

Subsequently, if a warm crank occurs, the ECU 150: (1) determines BattCrankVoltage of a warm crank that has most recently occurred; (2) adjusts R_StarterCable with BattCrankVoltage; (3) calculates the predicted minimum battery voltage V_Crank_Predicted based on R_StarterCable; (4) compares the predicted minimum battery voltage V_Crank_Predicted to the minimum acceptable voltage threshold V_MinCrank_Threhsold; and (5) enables or disables the SS function based on the comparison. The ECU 150 may repeat these steps for each instance in which a warm crank occurs.

In some examples, during a period defined by two consecutive instances within a key cycle and in which an engine crank occurs, the ECU 150 may perform multiple iterations of: (1) calculating the predicted minimum battery voltage V_Crank_Predicted based on R_StarterCable; (2) compares the predicted minimum battery voltage V_Crank_Predicted to the minimum acceptable voltage threshold V_MinCrank_Threhsold; and (3) enables or disables the SS function based on the comparison. For each iteration, the ECU 150 may update at least one variable of V_Crank_Predicted and/or R_starterCable by measuring said variable at a timing in which said iteration is performed. For example, said variables may include, but is not limited to, V_BeforeCrank and R_Battery_Internal.

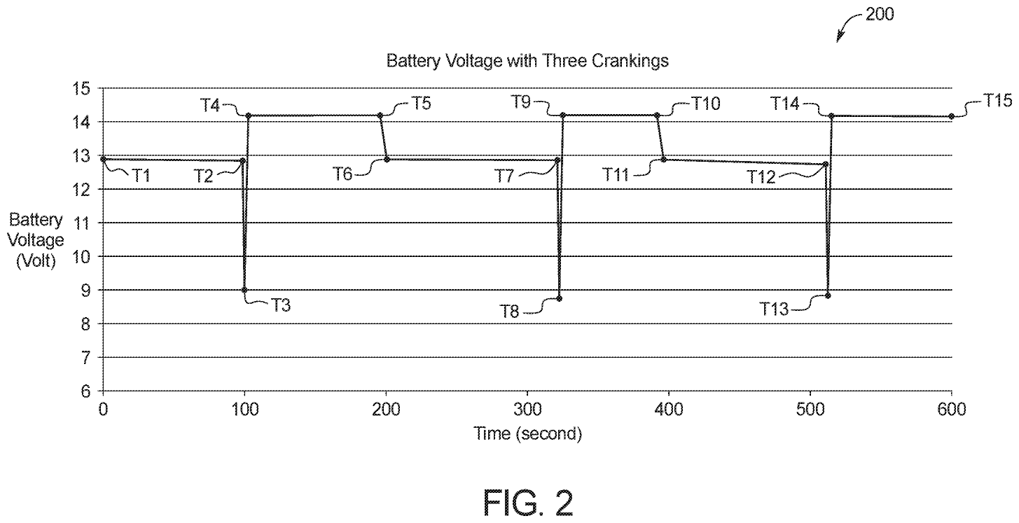

FIG. 2 illustrates an example graph 200 of battery voltage change over time. The battery voltage resembles the voltage level of the power source 112 of the vehicle of FIG. 1. The example graph 200 is described herein with reference to an example scenario in which three engine cranks occur within a key cycle. In this examples scenario, the minimum acceptable voltage threshold is 7 volts.

At T1, the vehicle is electrically powered. For example, T1 may be a time point in which a key is inserted in a key hole for activating the vehicle ignition. From T1 to T2, the ECU 150 calculates the predicted minimum battery voltage V_Crank_predicted based on equation 1. During this period, R_StarterCable is defined as a predetermined value stored in memory, and the predicted minimum battery voltage V_Crank_predicted is determined as 8.5 V. At T2, the first engine crank (i.e., cold crank) occurs, and the battery voltage begins to drop. T2-T4 may define the duration of the first engine crank. At T3, the battery voltage reaches the minimum voltage level for the first engine crank, and the ECU 150 defines this voltage level as BattCrankVoltage. From T4 to any time point after T4 and before T5, the ECU 150: (1) calculates R_StarterCable based on equation 3; (2) calculates the predicted minimum battery voltage V_Crank_predicted based on R_StarterCable; (3) compares the predicted minimum battery voltage V_Crank_predicted to the minimum acceptable voltage threshold V_MinCrank_Threshold; and (4) enables or disables the SS function based on the comparison. During this period, the predicted minimum battery voltage V_Crank_predicted is determined as 9 V. Since the predicted minimum battery voltage V_Crank_predicted is greater than the minimum acceptable voltage threshold V_MinCrank_Threshold, the ECU 150 enables (or maintains enablement of) the SS function. At T5, a vehicle brake pedal is compressed, and in response, the battery voltage drops. At T7, the second engine crank occurs, and the battery voltage further drops. T7-T9 may define the duration of the second engine crank. At T8, the battery voltage reaches the minimum voltage level for the second engine crank, and the ECU 150 defines this voltage level as BattCrankVoltage. From T9 to any time point after T9 and before T10, the ECU 150: (1) calculates R_StarterCable based on equation 3; (2) calculates the predicted minimum battery voltage V_Crank_predicted based on R_StarterCable; (3) compares the predicted minimum battery voltage V_Crank_predicted to the minimum acceptable voltage threshold V_MinCrank_Threshold; and (4) enables or disables the SS function based on the comparison. During this period, the predicted minimum battery voltage V_Crank_predicted is determined as 8.875 V. Since the predicted minimum battery voltage V_Crank_predicted is greater than the minimum acceptable voltage threshold V_MinCrank_Threshold, the ECU 150 maintains enablement of the SS function. Operations at T10 to T15 may be similar to those at T5-T10, as described above, therefore, said operations will not be repeated herein for sake of brevity.

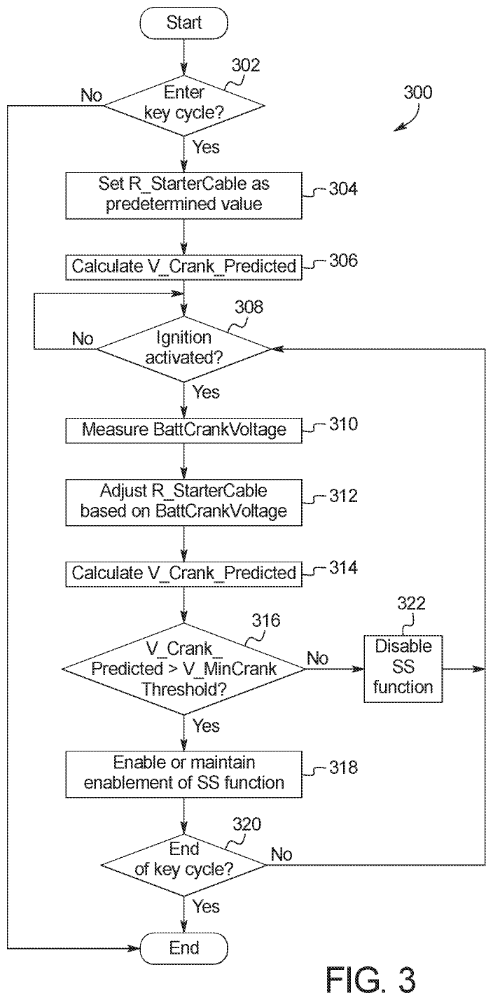

FIG. 3 illustrates an example flowchart of a method for controlling the SS function based on measured and predicted cranking voltages and adaptive adjustment of starter resistance, which may be executed by one or more components as illustrated in FIG. 1.

At block 302, the ECU 150 determines whether determines whether a key cycle has started. If so, the method continues to block 304. Otherwise, the method terminates.

At block 304, the ECU 150 sets R_StarterCable as predetermined value stored in memory.

At block 306, the ECU 150: (1) calculates EMF, I_load 114, R_load 114, and R_Battery_Internal based on sensor data; (2) calculates V_BeforeCrank; and (3) calculates V_Crank_Predicted based on V_BeforeCrank, R_StarterCable, and R_Battery_Internal.

At block 308, the ECU 150 determines whether a vehicle ignition has been activated. If so, the method continues to block 310. Otherwise, the method returns to block 308.

At block 310, the ECU 150 measures BattCrankVoltage.

At block 312, the ECU 150 adjusts R_starterCable based on BattCrankVoltage.

At block 314, the ECU 150 calculates V_Crank_Predicted based on R_StarterCable.

At block 316, the ECU 150 determines whether V_Crank_Predicted is greater than V_MinCrank_Threshold. If so, the method continues to block 320. Otherwise, the method continues to block 322.

At block 318, the ECU 150 enables or maintains enablement of SS function.

At block 320, the ECU 150 determines whether the key cycle has ended. If so, the method terminates. Otherwise, the method returns to block 308.

At block 322, the ECU 150 disables the SS function.

The flowchart of FIG. 3 is representative of machine readable instructions stored in memory (such as the memory 134 of FIG. 1) that comprise one or more programs that, when executed by a processor (such as the processor 132 of FIG. 1), causes the processor to execute each of the block as shown in the flowchart of FIG. 3. Further, although the example program(s) is/are described with reference to the flowchart illustrated in FIG. 3, many other methods may alternatively be performed. For example, the order of execution of the blocks may be changed, and/or some of the blocks described may be changed, eliminated, or combined.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. As used here, the terms “module” and “unit” refer to hardware with circuitry to provide communication, control and/or monitoring capabilities, often in conjunction with sensors. “Modules” and “units” may also include firmware that executes on the circuitry. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
at least one load;
a starter motor;
a starter cable connected to the starter motor;
sensors;
a power source electrically coupled to the starter motor and said load;
a processor; and
memory storing instructions executable by the processor, the instructions, when executed by the processor, cause the processor to operate with the sensors to:
during an engine crank, determine a first voltage of the power source;
determine a first resistance of the starter motor and the starter cable based at least in part on the first voltage of the power source;
determine a predicted minimum battery voltage based at least in part on the first resistance of the starter motor and the starter cable;
responsive to the predicted minimum battery voltage satisfying a threshold, enable a vehicle stop-start function; and
responsive to the predicted minimum battery voltage failing to satisfy the threshold, disable the vehicle stop-start function.

2. The vehicle of claim 1, wherein the first voltage of the power source correspond to a minimum voltage measured by the sensors during the engine crank.

3. The vehicle of claim 1, wherein the instructions, when executed by the processor, further cause the processor to operate with the sensors to:
determine an internal resistance of the power source;
determine a second voltage based on an electromagnetic force of the power source, a first amount of current consumed by said load, and a second resistance of said load; and
determine the first resistance of the starter motor and the starter cable based on the internal resistance of the power source, the second voltage, and the first voltage of the power source.

4. The vehicle of claim 3, wherein the second voltage is a difference between the electromagnetic force of the power source and a product of the first amount of current consumed by said load and the second resistance of said load.

5. The vehicle of claim 3, wherein the first resistance of the starter motor and the starter cable is a ratio of a first value and a second value, wherein the first value is a product of the first voltage of the power source and the internal resistance of the power source, and wherein the second value is a difference between the second voltage and the first voltage of the power source.

6. The vehicle of claim 1, wherein the instructions, when executed by the processor, further cause the processor to operate with the sensors to:
determine an internal resistance of the power source;
determine a second voltage based on an electromagnetic force of the power source, a first amount of current consumed by said load, and a second resistance of said load; and
determine the predicted minimum battery voltage based on the second voltage, the internal resistance of the power source, and the first resistance of the starter motor and the starter cable.

7. The vehicle of claim 6, wherein the predicted minimum battery voltage is a ratio of a first value and a second value, wherein the first value is a product of the second voltage and the first resistance of the starter motor and the starter cable, and wherein the second value is a sum of the first resistance of the starter motor and the starter cable and the internal resistance of the power source.

8. The vehicle of claim 1, wherein the instructions, when executed by the processor, further cause the processor to operate with the sensors to:
before the engine crank:
set the first resistance of the starter motor and the starter cable as a predetermined value stored in the memory; and
determine the predicted minimum battery voltage based at least in part on the first resistance of the starter motor and the starter cable.

9. The vehicle of claim 1, wherein the instructions, when executed by the processor, further cause the processor to operate with the sensors to:
prior to a first engine crank within a key cycle:
set the first resistance of the starter motor and the starter cable as a predetermined value stored in the memory; and
determine the predicted minimum battery voltage based at least in part on the first resistance of the starter motor and the starter cable.

10. The vehicle of claim 1, further comprising an alternator electrically coupled to the power source.

11. A method comprising:
during a vehicle engine crank, determining via, vehicle a first voltage of a power source of a vehicle, wherein the power source is electrically coupled to a starter motor of the vehicle and at least one load of the vehicle;
determining a first resistance of a starter motor of the vehicle and a starter cable of the vehicle based at least in part on the first voltage of the power source;
determining a predicted minimum battery voltage based at least in part on the first resistance of the starter motor and the starter cable;
responsive to the predicted minimum battery voltage satisfying a threshold, enabling a vehicle stop-start function; and
responsive to the predicted minimum battery voltage failing to satisfy the threshold, disabling the vehicle stop-start function.

12. The method of claim 11, wherein the first voltage of the power source correspond to a minimum voltage measured by the sensors during the engine crank.

13. The method of claim 11, further comprising:
determining an internal resistance of the power source;
determining a second voltage based on an electromagnetic force of the power source, a first amount of current consumed by said load, and a second resistance of said load; and
determining the first resistance of the starter motor and the starter cable based on the internal resistance of the power source, the second voltage, and the first voltage of the power source.

14. The method of claim 13, wherein the second voltage is a difference between the electromagnetic force of the power source and a product of the first amount of current consumed by said load and the second resistance of said load.

15. The method of claim 13, wherein the first resistance of the starter motor and the starter cable is a ratio of a first value and a second value, wherein the first value is a product of the first voltage of the power source and the internal resistance of the power source, and wherein the second value is a difference between the second voltage and the first voltage of the power source.

16. The method of claim 11, further comprising:
determining an internal resistance of the power source;
determining a second voltage based on an electromagnetic force of the power source, a first amount of current consumed by said load, and a second resistance of said load; and
determining the predicted minimum battery voltage based on the second voltage, the internal resistance of the power source, and the first resistance of the starter motor and the starter cable.

17. The method of claim 16, wherein the predicted minimum battery voltage is a ratio of a first value and a second value, wherein the first value is a product of the second voltage and the first resistance of the starter motor and the starter cable, and wherein the second value is a sum of the first resistance of the starter motor and the starter cable and the internal resistance of the power source.

18. The method of claim 11, further comprising:
before the engine crank:
setting the first resistance of the starter motor and the starter cable as a predetermined value stored in the memory; and
determining the predicted minimum battery voltage based at least in part on the first resistance of the starter motor and the starter cable.

19. The method of claim 11, further comprising:
prior to a first engine crank within a key cycle:
setting the first resistance of the starter motor and the starter cable as a predetermined value stored in the memory; and
determining the predicted minimum battery voltage based at least in part on the first resistance of the starter motor and the starter cable.

20. The method of claim 11, wherein the power source is further electrically coupled to an alternator of the vehicle.
